(19) United States
(12) Patent Application Publication
(10) Pub. No.: US 2026/0058259 A1
(43) Pub. Date: Feb. 26, 2026

(54) BATTERY ASSEMBLY AND MANUFACTURING METHOD FOR BATTERY ASSEMBLY

(71) Applicant: SK On Co., Ltd., Seoul (KR)

(72) Inventors: Gang U LEE, Daejeon (KR); Chae Won NA, Daejeon (KR); Yun Joo NOH, Daejeon (KR)

(21) Appl. No.: 19/303,379

(22) Filed: Aug. 19, 2025

(30) Foreign Application Priority Data
Aug. 20, 2024 (KR) 10-2024-0111032

(51) Int. Cl. H01M 50/124; H01M 50/143; H01M 50/186; H01M 50/198; H01M 50/505

(52) U.S. Cl. CPC H01M 50/1245; H01M 50/143; H01M 50/186; H01M 50/198; H01M 50/505

(57) ABSTRACT

The present disclosure relates to a battery assembly comprising a plurality of battery cells stacked along a direction; and a housing accommodating the plurality of battery cells; wherein each of the plurality of battery cells may include an electrode assembly, an outer body accommodating the electrode assembly, and a tab portion protruding outwardly from the outer body, and wherein a portion of the outer body of at least one battery cell among the plurality of battery cells may be coated with a fire-resistant material.

### CROSS-REFERENCE TO RELATED PATENT APPLICATION

The present application claims priority under 35 U.S.C. § 119(a) to Korean patent application number 10-2024-0111032 filed on Aug. 20, 2024, in the Korean Intellectual Property Office, the entire disclosure of which is incorporated by reference herein.

### BACKGROUND OF THE INVENTION

### 1. Field

The present disclosure relates to a battery assembly and a manufacturing method for battery assembly.

### 2. Description of the Related Art

A secondary battery is a battery that converts electrical energy into chemical energy and stores it so that it can be reused multiple times through charging and discharging. Secondary batteries are widely used in various industries due to their economical and eco-friendly characteristics. In particular, lithium secondary batteries are widely used across industries, including mobile devices that require high-density energy.

Secondary batteries can generate a large amount of heat during charging and discharging. If the heat generated internally is not quickly extinguished, heat or fire can spread to neighboring battery cells, causing significant damage. Therefore, one of the major challenges is to quickly extinguish the heat generated inside the secondary battery and suppress the propagation of heat or fire.

The problem addressed by the present disclosure is to provide battery cells and battery assembly with improved safety.

Another problem addressed by present disclosure is to provide battery assembly that can retard the propagation of heat or fire.

Furthermore, the present disclosure can be widely applied in the field of green technology such as electric vehicle, battery charging station, energy storage system (ESS), photovoltaics, wind power, etc. that utilize batteries. In addition, the battery cell manufactured using the battery manufacturing apparatus and the controlling method according to the present disclosure can be used for eco-friendly mobility, including electric vehicles and hybrid vehicles to prevent climate change by suppressing air pollution and greenhouse gas emissions.

### SUMMARY OF THE INVENTION

A battery assembly according to an embodiment of the present disclosure may comprise: a plurality of battery cells stacked; and a housing accommodating the plurality of battery cells; wherein each of the plurality of battery cells may include an electrode assembly, an outer body accommodating the electrode assembly, and a tab portion protruding outwardly from the outer body, and wherein a portion of the outer body of at least one battery cell among the plurality of battery cells may be coated with a fire-resistant material.

In embodiment, the outer body may include an accommodating portion forming an accommodating space for accommodating the electrode assembly and a sealing portion sealing the accommodating portion along an outer side of the accommodating portion.

In embodiment, the sealing portion may include a first sealing portion from which the tab portion protrudes; and a second sealing portion connected to the first sealing portion and formed on at least one side of the outer side of the accommodating portion from which the tab portion does not protrude.

In embodiment, the sealing portion of the outer body may be coated with the fire-resistant material.

In embodiment, only the first sealing portion among the first sealing portion and the second sealing portion may be coated with the fire-resistant material.

In embodiment, the battery assembly may further comprise: a busbar assembly electrically connecting the plurality of battery cells, wherein each tab portion of the plurality of battery cells may be inserted into a through hole of the busbar assembly.

In embodiment, each of the first sealing portion provided in the plurality of battery cells may include an extension region formed within a preset distance along a direction in which the tab portion protrudes from the accommodating portion and an insertion region formed from the extension region toward one end of the tab portion, and only the extension region may be coated with the fire-resistant material.

In embodiment, a length of the extension region may be longer than a length of the insertion region along the direction in which the tab portion protrudes.

In embodiment, the fire-resistant material may be foamed at or above a preset temperature.

In embodiment, the fire-resistant material may comprise at least one of polyurethane, silica, or ceramic.

In embodiment, the fire-resistant material may have insulating properties.

In embodiment, the fire-resistant material coated on at least one of the battery cells may be foamed, the fire-resistant material contacts with a fire-resistant material coated on another battery cell adjacent to the at least one battery cell.

A method of manufacturing a battery assembly including an electrode assembly, an outer body for accommodating the electrode assembly, a plurality of battery cells each including a tab portion protruding outwardly from the outer body, and a housing for accommodating the plurality of battery cells according to another embodiment of the present disclosure may comprise: a step of coating at least one battery cell among the plurality of battery cells with a fire-resistant material; and a step of curing the fire-resistant material at or below a preset temperature.

In another embodiment, the step of coating at least one battery cell among the plurality of battery cells with the fire-resistant material may include a step of covering an accommodating portion forming an accommodating space for accommodating the electrode assembly among the outer body and a step of spraying the fire-resistant material toward the outer body.

In accordance with one aspect of the present disclosure, the properties of the battery cells and battery assembly can be improved.

In accordance with another aspect of the present disclosure, the spread of heat or fire in battery cells and battery assemblies can be delayed.

### BRIEF DESCRIPTION OF THE DRAWINGS

FIG. 1 illustrates a battery assembly according to one embodiment of the present disclosure.

FIG. 2 illustrates a battery cell according to one embodiment of the present disclosure.

FIG. 3 is a cross-sectional view of a battery assembly according to one embodiment of the present disclosure.

FIG. 4 is a side view of a battery cell according to one embodiment of the present disclosure.

FIG. 5 illustrates a fire-resistant material coated in accordance with one embodiment of the present disclosure.

FIG. 6 illustrates the fire-resistant material foamed in accordance with one embodiment of the present disclosure.

FIG. 7 is a schematic cross-sectional view of a foamed fire-resistant material according to one embodiment of the present disclosure.

FIG. 8 illustrates a method of manufacturing a battery assembly according to one embodiment of the present disclosure.

FIG. 9 is an illustration of coating a fire-resistant material on a battery cell according to one embodiment of the present disclosure.

### DETAILED DESCRIPTION

Embodiments of the present disclosure will be described in detail hereinafter with reference to the accompanying drawings. The apparatus configurations and controlling methods described herein are intended to illustrate embodiments of the present disclosure and are not intended to limit the scope of the present disclosure, and like reference numerals used throughout the specification refer to like components.

Certain terms used herein are for convenience of description only and are not intended to be limiting to the exemplary embodiments.

For example, expressions such as “identical” and “identical to” refer not only to a state of being strictly identical, but also to a state of being subject to tolerances, or differences in the degree to which the same function is obtained.

For example, expressions such as “in a direction,” “along a direction,” “side by side,” “perpendicular,” “centered,” “concentric,” or “coaxial” that indicate a relative or absolute placement do not strictly indicate such placement, but also indicate a state of relative displacement with a tolerance, or an angle or distance such that the same function is obtained.

For the purposes of describing the present disclosure, the following description is based on a spatial Cartesian coordinate system with the X, Y, and Z axes orthogonal to each other. Each axial direction (X-axis direction, Y-axis direction, Z-axis direction) means both directions in which the respective axis extends.

References herein to the X, Y, and Z directions are intended to be descriptive so that the present disclosure may be clearly understood and may of course be defined differently depending on the reference.

The use of terms such as “first,” “second,” “third,” and the like to precede components referred to herein is intended to avoid confusion as to the components to which they refer, and is not intended to indicate any order, importance, or master-servant relationship among the components. For example, it is possible to practice an invention comprising only the second component without the first component.

The terminology used in this disclosure is for the purpose of describing specific embodiments and is not intended to limit the scope of the claims. As used in the description of the embodiments and the appended claims, singular forms are intended to include plural forms unless the context clearly indicates otherwise.

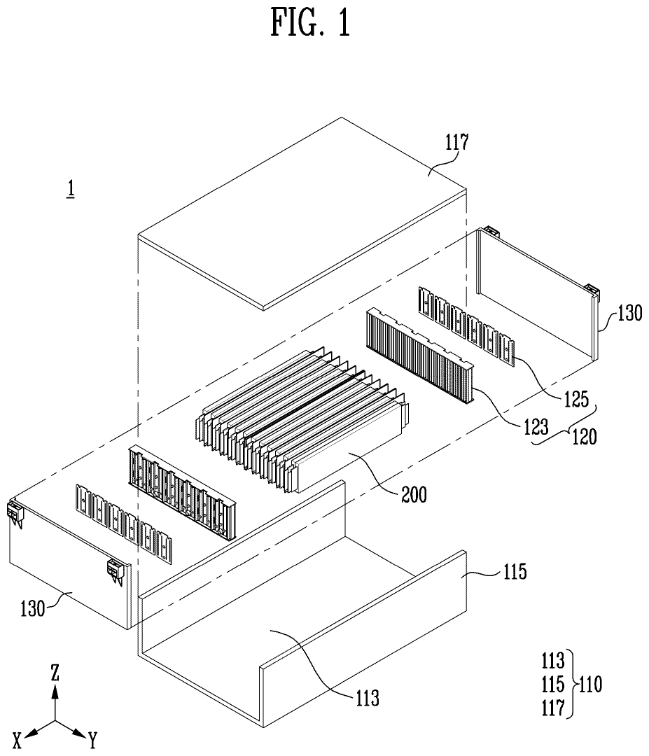

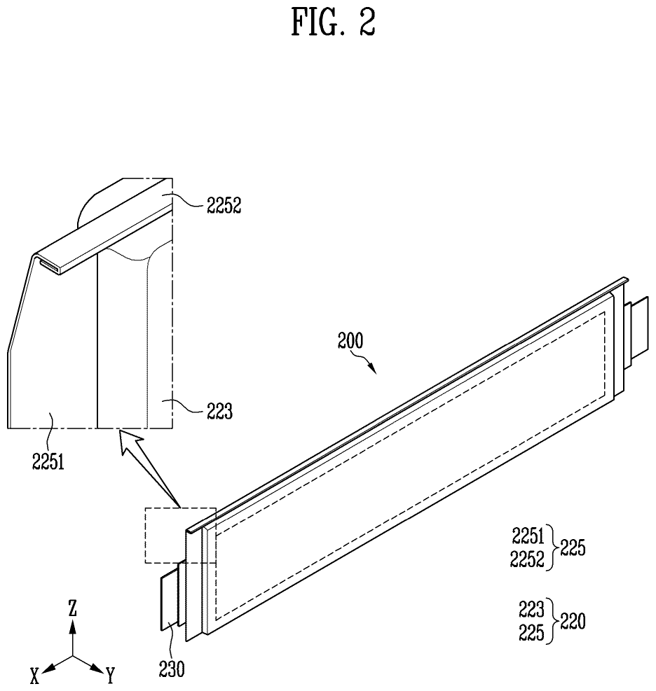

FIG. 1 illustrates a battery assembly 100 according to one embodiment of the present disclosure, and FIG. 2 illustrates a battery cell 200 according to one embodiment of the present disclosure.

The battery assembly 100 of the present disclosure includes a plurality of battery cells 200 stacked along a direction; and a housing 110 accommodating the plurality of battery cells; wherein each of the plurality of battery cells 200 includes an electrode assembly 210, an outer body 220 accommodating the electrode assembly 210, and a tab 230 portion protruding outwardly from the outer body 220, and wherein a portion of the outer body of at least one battery cell among the plurality of battery cells 200 is coated with a fire-resistant material 300.

Referring to FIG. 1, the battery assembly 100 includes a plurality of battery cells 200. The plurality of battery cells 200 may be stacked along a preset direction. For example, the plurality of battery cells 200 may be stacked along a y-axis direction. As used herein, a stacking direction of the plurality of battery cells 200 may refer to the Y-axis direction.

Battery cell 200 refers to a secondary battery that can be used repeatedly by charging and discharging electrical energy. In one example, the battery cell 200 may be a lithium rechargeable battery or a lithium ion battery. In another example, it may refer to an all-solid-state battery.

The battery cell 200 may be categorized as a pouch rechargeable battery, a prismatic rechargeable battery, or a cylindrical rechargeable battery based on its shape. For ease of illustration, a pouch type secondary battery is shown herein as an example, but is not limited thereto.

The plurality of battery cells 200 each include an electrode assembly 210, an outer body 220 that receives the electrode assembly 210, and tab portion 230 protruding outwardly from the outer body 220. The electrode assembly 210 can include an anode and a cathode. The electrode assembly 210 may further include a separator disposed between the anode and the cathode.

The electrode assembly 210 may be categorized as stacking, winding, stack-folding, or Z-stacking depending on how the anode, cathode, and separator are stacked. The battery cell 200 of the present disclosure may include electrode assembly 210 stacked in various ways, without limitation to any one stacking method.

An outer body 220 may receive the electrode assembly 210. The outer body 220 may include an accommodating portion 223 forming an accommodating space for accommodating the electrode assembly 210; and a sealing portion 225 sealing the accommodating portion 223 along an exterior side of the accommodating portion 223.

The outer body 220 may comprise an outer insulating layer and an inner adhesive layer made of a polymeric material, and a metal layer interposed between the outer insulating layer and the inner adhesive layer. The outer body 220 may include a material with high mechanical rigidity to protect the battery cell 200 from external impact. For example, the outer body 220 may include an aluminum layer.

In an embodiment, the outer body 220 may be formed in a sheet-like shape with an inner adhesive layer/metal layer/outer insulation layer laminated sequentially from the inside toward the outside. A region of the sheet-like outer body 220 may be depressed to form an accommodating portion 223, and the electrode assembly 210 may be received in the accommodating portion 223.

The battery cell 200 may further include an electrolyte. The electrolyte may include an electrolyte solution. The electrolyte may be a non-aqueous electrolyte. The electrolyte may include a lithium salt and an organic solvent. The electrolyte may further comprise an additive. The additive may form a film on the anode or cathode through a chemical reaction inside the battery. For example, an anodic film may be formed on the anode and a cathodic film may be formed on the cathode.

The sealing portion 225 can seal the accommodating portion 223 along an outer side of the accommodating portion 223. This allows the sealing portion 225 to hermetically seal the accommodating portion 223 and prevent electrolyte from leaking out of the outer body 220. Referring to FIG. 2, the accommodating portion 223 may be formed in a central region of the outer body 220, and the sealing portion 225 may be formed along an outer side of the accommodating portion 223.

In embodiments, the outer body may include a first pouch and a second pouch. The recessed accommodating portion 223 may be formed in at least one of the first pouch and the second pouch. The accommodating portion 223 of the pouch may receive the electrode assembly 210. The first pouch and the second pouch may be provided with sealing portions along the outer peripheral surface. The sealing portions may be bonded to each other to seal the accommodating portion 223 in which the electrode assembly 210 is accommodated.

The tab portion 230 may protrude outwardly from the outer surface of the outer body 220. Referring to FIGS. 1 and 2, each tab portion 230 may protrude outwardly of the outer body 220 along the x-axis direction. As used herein, the protruding direction of the tab portion 230 may refer to the X-axis direction.

The tab portion 230 allows the electrode assembly 210 to be electrically connected to the outside. The tab portion 230 may include an anode tab in connection with an anode and a cathode tab in connection with a cathode. In embodiments, the anode tab and the cathode tab may be located in opposite directions.

In an embodiment, the sealing portion 225 may include a first sealing portion 2251 from which the tab portion 230 protrudes; and a second sealing portion 2252 connected to the first sealing portion 2251 and formed on at least one side of the outer side of the accommodating portion from which the tab portion 230 does not protrude.

In another embodiment, the sealing portion 225 may include a first sealing portion 2251 from which the tab portion 230 protrude; and a second sealing portion 2252 connected to the first sealing portion 2251 and formed in line with the protruding direction of the tab portion 230.

One end of the tab portion 230 may be connected to the electrode assembly 210 located at the accommodating portion 223, and the other end of the tab portion 230 may protrude outwardly. A first sealing portion 2251 may be a region of the outer body 220 from which the tab portion 230 protrudes. A second sealing portion 2252 may be connected to the first sealing portion 2251 and formed in line with the protruding direction of the tab portion 230.

Referring to FIG. 2, the tab portion 230 may protrude outwardly from the outer surface of the outer body 220 along the X-axis direction. Further, the first sealing portion 2251 may be positioned on the outer side of the accommodating portion 223 along the X-axis direction, respectively. Along the X-axis direction, a positive pole tab may protrude from the forwardly positioned first sealing portion 2251 and a negative pole tab may protrude from the rearwardly positioned first sealing portion 2251. A second sealing portion 2252 may be connected to the first sealing portion 2251 and may extend along the Y-axis direction.

The battery assembly 100 includes a housing 110. The housing 110 may accommodate a plurality of battery cells 200 within its interior. The housing 110 may protect the plurality of battery cells 200 from external heat, shock, or vibration.

The housing 110 may include a lower housing 113 and an upper housing 117. The lower housing 113 may support a plurality of battery cells 200. The plurality of battery cells 200 may be disposed on the lower housing 113. The upper housing 117 may cover one side of the plurality of battery cells 200. The lower housing 113 and the side housing 115 may be connected to form a compartment therein.

The housing 110 may further include a side housing 115. The side housing 115 may protect the sides of the plurality of battery cells 200. The side housing 115 may be disposed on either side of the plurality of battery cells 200 along a direction in which the plurality of battery cells 200 are stacked.

The side housings 115 may extend from the lower housing 113 along the direction in which the plurality of battery cells 200 are located. Referring to FIG. 1, the side housings 115 may be connected to the lower housing 113 to form a tunnel structure with open front and back sides. In this case, the upper housing 117 may be connected to the side housing 115.

The battery assembly 100 of the present disclosure may further comprise an endplate 130. The endplate 130 may be coupled to the housing 110 to close the accommodating space. The endplates 130 may be disposed on a front and a back of the plurality of battery cells 200, respectively. Here, front and back may refer to the directions in which each tab portion 230 of the plurality of battery cells 200 protrudes. Referring to FIG. 1, endplates 130 may be positioned on each side of the plurality of battery cells 200 along the X-axis direction.

The battery assembly 100 of the present disclosure may further comprise a busbar assembly 120 electrically connecting the plurality of battery cells 200, and at least a portion of each tab portion 230 of the plurality of battery cells 200 may be inserted into a through hole 127 of the busbar assembly 120.

The busbar assembly 120 may include a busbar plate 123 and a busbar 125. The busbar plate 123 may support the busbar 125. The busbar 125 may be connected to the busbar plate 123. The busbar plate 123 may be disposed between the plurality of battery cells 200 and the busbar 125.

Referring to FIG. 1, a busbar plate 123 may be disposed on each side of the plurality of battery cells 200 along the X-axis direction. The busbar 125 may be connected to opposite sides of the two sides of the busbar plate 123 that face the plurality of battery cells 200.

The busbar plate 123 may be formed of an insulating material, i.e., the busbar plate 123 may be electrically insulated from the plurality of battery cells 200. The busbar 125 may be formed of a conductive material. The busbar 125 may be electrically connected to the plurality of battery cells 200.

The busbar assembly 120 may further include a through hole 127. Each tab portion 230 of the plurality of battery cells 200 may be inserted into the through hole 127. The through hole 127 allows the plurality of battery cells 200 to be securely connected to the busbar 125.

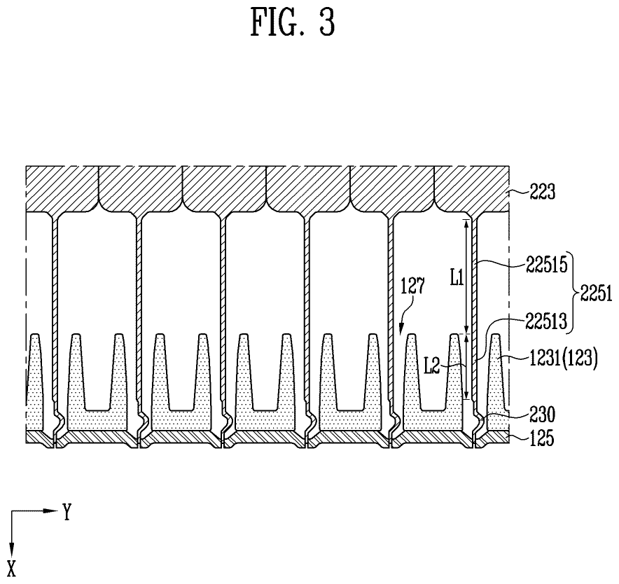

FIG. 3 is a cross-sectional view of a battery assembly according to one embodiment of the present disclosure.

The busbar assembly 120 may extend along the direction in which the plurality of battery cells 200 are stacked, i.e., the busbar plate 123 may extend along the direction in which the plurality of battery cells 200 are stacked (e.g., along the Y-axis), and the busbar 125 may extend along the direction in which the plurality of battery cells 200 are stacked.

The through hole 127 may be disposed at preset intervals along the direction in which the plurality of battery cells 200 are stacked. Each of the tab portion 230 of the plurality of battery cells 200 may be inserted into the through hole 127.

A first side of the busbar plate 123 may include a protrusion 1231. The protrusions 1231 may protrude from the first side of the busbar plate 123 in a direction in which the plurality of battery cells 200 are located. A through hole 127 may be formed between each of the plurality of protrusions 1231. Eventually, referring to FIG. 3, each tab portion 230 of the plurality of battery cells 200 may protrude outwardly of the busbar plate 123 after being inserted between the plurality of protrusions 1231.

The tab portion 230 may be inserted into the through hole 127. When the tab portion 230 is inserted into the through hole 127, a portion of the first sealing portion 2251 sealing the tab portion 230 may be inserted into the through hole 127. Referring to FIG. 3, a portion of the first sealing portion 2251 adjacent to the tab portion 230 is inserted into the through hole 127, and another portion of the first sealing portion 2251 may be positioned between the busbar assembly 120 and the plurality of battery cells 200.

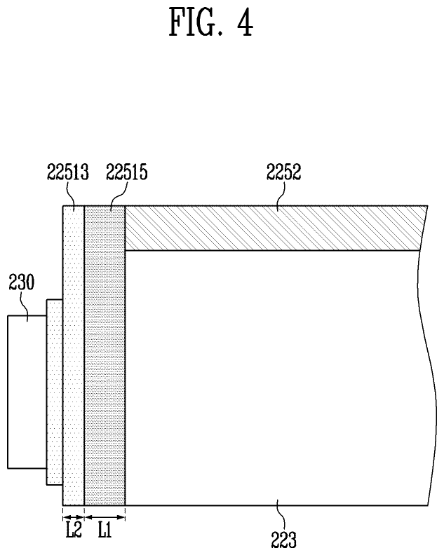

FIG. 4 is a side view of a battery cell according to one embodiment of the present disclosure.

Each of the first sealing portion 2251 provided in the plurality of battery cells 200 may include an extension region 22515 formed within a preset distance along the direction in which the tab portion 230 protrudes from the accommodating portion 223 and an insertion region 22513 formed from the extension region 22515 toward an end of the tab portion 230.

The first sealing portion 2251 can include an extension region 22515 located adjacent to the accommodating portion 223 and an insertion region 22513 that forms a first end of the tab portion 230 from the extension region 22515. The extension region 22515 may be located within a preset distance along the direction in which the tab portion 230 protrudes from the accommodating portion 223.

The insertion region 22513 may be formed toward an end of the tab portion 230 from the extension region 22515. When the battery cell 200 is inserted into the busbar assembly 120, the insertion region 22513 may be a region located in the through hole 127. Referring to FIGS. 3 and 4, the extension region 22515 may be located within a preset distance L1 from the accommodating portion 223. The insertion region 22513 may be formed toward an end of the tab portion 230 from the extension region 22515.

Along the direction in which the tab portion 230 protrudes, the length of the extension region 22515 may be longer than the length of the insertion region 22513. By forming a longer length of the extension region 22515, a region of the first sealing portion 2251 that is located between the busbar assembly 120 and the plurality of battery cells 200 may be larger than a region that is located between the through hole 127.

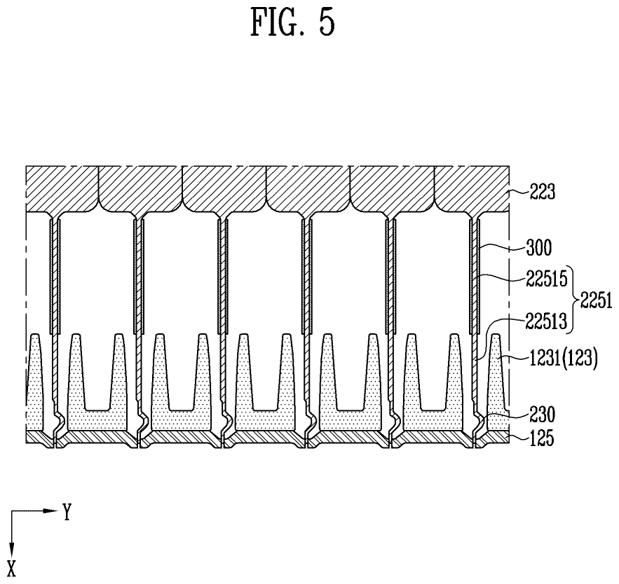

FIG. 5 illustrates a fire-resistant material coated in accordance with one embodiment of the present disclosure.

At least one of the battery cells 200 of the plurality of battery cells 200 may have a portion of the outer body 220 coated with the fire-resistant material 300. A portion of the outer body 220 of all of the battery cells 200 of the plurality of battery cells 200 may be coated with the fire-resistant material 300, or only some of the battery cells 200 of the plurality of battery cells 200 may have a portion of the outer body 220 coated with the fire-resistant material 300.

The fire-resistant material may be a member having a thermal conductivity equal to or below a threshold value. The fire-resistant material may inhibit heat transfer to the surroundings. The fire-resistant material 300 may be fire resistant. Fire resistance can mean being resistant to heat or flame. When the fire-resistant material 300 is used, the heat transfer to the battery assembly 100 can be delayed, and the propagation of fire can be delayed.

The coating thickness of the fire-resistant material 300 may be 0.2 mm to 0.3 mm. However, the coating thickness of the fire-resistant material 300 may vary in consideration of the foaming property and fire resistance of the fire-resistant material 300.

Furthermore, the fire-resistant material may be coated by various methods. In an embodiment, the fire-resistant material may be applied to a portion of the outer body. The fire-resistant material may be sprayed onto a portion of the outer body. The fire-resistant material may be injected into a portion of the outer body. The fire-resistant material may be attached to a portion of the outer body.

The fire-resistant material 300 may have insulating properties. The fire-resistant material may be an electrically insulating member having an electrical conductivity equal to or below a threshold value. The fire-resistant material may prevent the electrical properties of the battery assembly from degrading.

The fire-resistant material 300 may include any one of polyurethane, silica, or ceramic. For example, the fire-resistant material 300 can include a variety of materials, such as polyurethane foam, polystyrene foam, polyethylene foam, and the like.

The fire-resistant material 300 may be foamed at or above a preset temperature. When the temperature of the battery assembly 100 rises at or above a preset temperature, the fire-resistant material 300 may foam to block the heat transfer path. In embodiments, the fire-resistant material 300 may be foamed at or above 150° C. If the fire-resistant material 300 is coated with a thin thickness, the effectiveness of retarding heat propagation may not be sufficient. As the fire-resistant material 300 is foamed, it may form voids 310 inside. This can increase the heat transfer resistance, which can effectively delay heat propagation.

In the event of a fire in any one of the battery cells 200, the heat or fire may propagate rapidly through the space formed between the busbar assembly 120 and the battery cells 200. Therefore, the space between the busbar assembly 120 and the battery cells 200 can be blocked with a fire-resistant material to delay heat propagation.

To this end, the present disclosure may coat the fire-resistant material 300 only with the sealing portion 225 of the outer body 220. Further, the sealing portion 225 of the outer body 220 may be coated with the fire-resistant material 300. When a plurality of battery cells 200 are stacked along a direction, the accommodating portions 223 of neighboring battery cells 200 may be in contact with each other. However, the sealing portions 225 may not contact each other and may form a space between the sealing portions 225. Thus, the space between the sealing portions 225 can be a pathway for heat propagation. The fire-resistant material 300 may be coated only on the sealing portion 225 to prevent it from being damaged by heat or flame.

Additionally, the fire-resistant material 300 may be foamed to fill the space between the sealing portions 225. The fire-resistant material 300 may delay heat propagation by blocking the heat propagation path.

In embodiments, only the first sealing portion 2251 among the first sealing portion 2251 and the second sealing portion 2252 may be coated with the fire-resistant material 300. By coating the first sealing portion 2251 with the fire-resistant material 300, heat propagation to the neighboring battery cell 200 can be effectively delayed in the region of the first sealing portion 2251 where heat propagation to the neighboring battery cell 200 is actively occurring.

In other embodiments, only the extension region 22515 may be coated with fire-resistant material 300. The insertion region 22513 of the first sealing portion 2251 may not be coated with the fire-resistant material 300 and only the extension region 22515 may be coated with the fire-resistant material 300. The insertion region 22513 may be located in the through hole 127. When the fire-resistant material 300 is coated at the insertion region 22513, the fire-resistant material 300 may expand and cause damage to the through hole 127. Therefore, the fire-resistant material 300 may not be coated at the insertion region 22513.

Referring to FIG. 5, an extension region 22515 of the first sealing portion 2251 may be coated with the fire-resistant material 300. The extension region 22515 of any one battery cell 200 may be positioned to face the extension region 22515 of an adjacent battery cell 200. Each of the extension region 22515 can be coated with the fire-resistant material 300.

Further, the length of the extension region 22515 along the protruding direction of the tab portion 230 may be longer than the length of the insertion region 22513. By forming the extension region 22515 longer than the insertion region 22513, the amount of coating on the fire-resistant material 300 can be increased, and heat propagation can be effectively retarded.

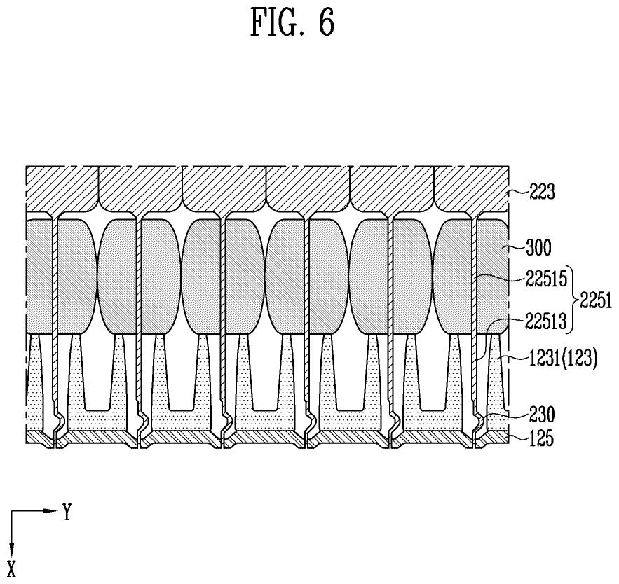

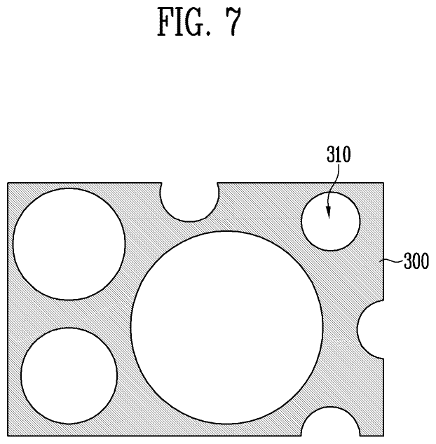

FIG. 6 illustrates the fire-resistant material 300 foamed in accordance with one embodiment of the present disclosure, and FIG. 7 is a schematic cross-sectional view of a foamed fire-resistant material 300 according to one embodiment of the present disclosure.

Referring to FIG. 6, the fire-resistant material 300 may be foamed to fill the space between the busbar assembly 120 and the plurality of battery cells 200. When the fire-resistant material 300 coated on at least one of the battery cells 200 is foamed, the fire-resistant material 300 may contact the fire-resistant material 300 coated on another battery cell 200 adjacent to the at least one battery cell 200, i.e., the fire-resistant material 300 coated on the extension region 22515 of two adjacent battery cells 200 may expand and come into contact with each other.

This allows a majority of the space between the busbar assembly 120 and the plurality of battery cells 200 to be filled with the fire-resistant material 300, and heat propagation can be effectively retarded.

FIG. 6 illustrates one embodiment of the fire-resistant material 300 in an expanded view. Not shown, the rate of expansion of the fire-resistant material 300 may vary. Furthermore, the fire-resistant material 300 that is coated on each battery cell 200 may not expand uniformly.

Referring to FIG. 7, the fire-resistant material 300 may include voids 310 within its interior. The voids 310 may be distributed within the fire-resistant material 300. The resistance to heat transfer may be increased by the voids 310, which may delay heat propagation. FIG. 7 illustrates one embodiment of the voids 310. It should be appreciated that the diameter of the voids 310 and the dispersion of the voids 310 may vary from that shown in FIG. 7.

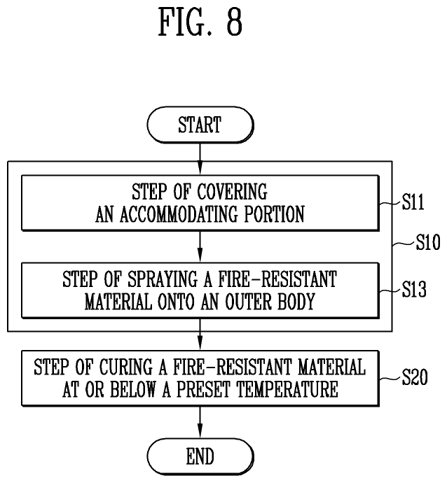

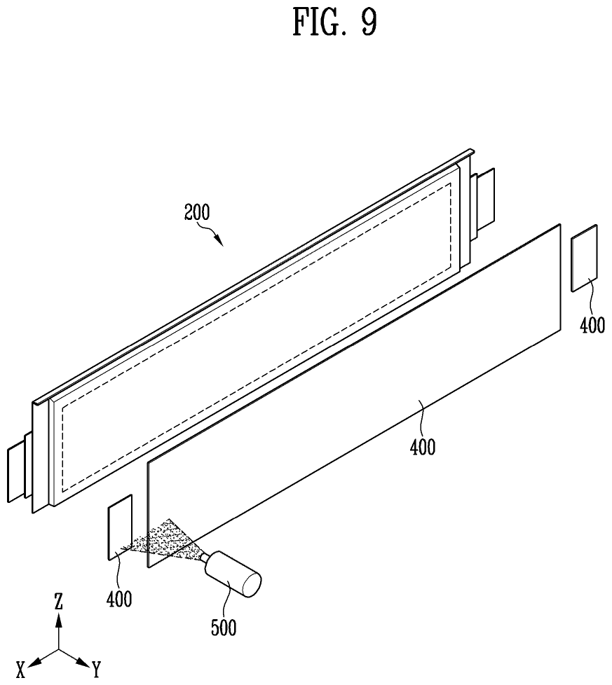

FIG. 8 illustrates a method of manufacturing a battery assembly 100 according to one embodiment of the present disclosure, and FIG. 9 is an illustration of coating a fire-resistant material 300 on a battery cell 200 according to one embodiment of the present disclosure.

The method of manufacturing the battery assembly 100 of the present disclosure includes a step S10 of coating at least one battery cell 200 of the plurality of battery cells 200 with the fire-resistant material 300; and a step S20 of curing the fire-resistant material 300 at or below a preset temperature.

Referring to FIG. 8, the present disclosure may proceed with the step S10 of coating at least one battery cell 200 of the plurality of battery cells 200 with the fire-resistant material 300 followed by the step S20 of curing the fire-resistant material at or below a preset temperature.

Curing the fire-resistant material 300 at or below a preset temperature is to prevent damage to the battery cell 200. In an embodiment, damage to the battery cell 200 may occur when the temperature is at or above 60° C. Therefore, the fire-resistant material 300 may use a material that cures at or below 60° C.

Furthermore, the step S10 of coating the fire-resistant material 300 on at least one of the battery cells 200 of the plurality of battery cells 200 may include the step S11 of covering the accommodating portion 223 wherein the cover portion 400 covers the accommodating portion 223 forming an accommodating portion space for accommodating the electrode assembly 210 of the outer body 220; and the step S13 of spraying the fire-resistant material 300 onto the outer body 220.

The step S13 of spraying the fire-resistant material 300 towards the outer body 220 may be performed after the step S11 of covering the accommodating portion 223, wherein the cover portion 400 covers the accommodating portion 223 forming an accommodating space for the electrode assembly 210 of the outer body 220.

Referring to FIG. 9, the cover portion 400 may cover the accommodating portion 223. This allows the accommodating portion 223 to be uncoated with the fire-resistant material 300. The cover portion 400 can be formed to fit over the area where the fire-resistant material 300 is not to be coated. In an embodiment, when the fire-resistant material 300 is formed only in the extension region 22515, the cover portion 400 may cover the battery cell 200 except for the region corresponding to the extension region 22515.

In embodiments, after the cover portion 400 covers the accommodating portion 223, the coating portion 500 may spray the fire-resistant material 300 toward the outer body 220. The battery cell 200 and the cover portion 400 may each be secured by a jig (not shown).

The above description of the present disclosure is for illustrative purposes only, and a person skilled in the art to which the present disclosure pertains will understand that the present disclosure may be easily modified into other specific forms without changing the technical idea or essential features of the present disclosure. Therefore, it should be understood that the embodiments described above are exemplary in all respects and not limiting. For example, each component described as a single entity may be implemented in a distributed manner, and likewise, components described as distributed may be implemented in a combined manner.

The scope of the present disclosure is indicated by the appended claims rather than the detailed description above, and all changes or modifications derived from the meaning and scope of the claims and their equivalent concepts should be construed as being included in the scope of the present disclosure.

What is claimed is:

1. A battery assembly comprising:
a plurality of battery cells stacked; and
a housing accommodating the plurality of battery cells;
wherein each of the plurality of battery cells includes an electrode assembly, an outer body accommodating the electrode assembly, and a tab portion protruding outwardly from the outer body, and
wherein a portion of the outer body of at least one battery cell among the plurality of battery cells is coated with a fire-resistant material.

2. The battery assembly according to claim 1, wherein the outer body includes an accommodating portion forming an accommodating space for accommodating the electrode assembly and a sealing portion sealing the accommodating portion along an outer side of the accommodating portion.

3. The battery assembly according to claim 2, wherein the sealing portion includes a first sealing portion from which the tab portion protrudes; and a second sealing portion connected to the first sealing portion and formed on at least one side of the outer side of the accommodating portion from which the tab portion does not protrude.

4. The battery assembly according to claim 3, wherein the sealing portion of the outer body is coated with the fire-resistant material.

5. The battery assembly according to claim 4, wherein only the first sealing portion among the first sealing portion and the second sealing portion is coated with the fire-resistant material.

6. The battery assembly according to claim 5, further comprising:
a busbar assembly electrically connecting the plurality of battery cells,
wherein each tab portion of the plurality of battery cells is inserted into a through hole of the busbar assembly.

7. The battery assembly according to claim 6, wherein each of the first sealing portion provided in the plurality of battery cells includes an extension region formed within a preset distance along a direction in which the tab portion protrudes from the accommodating portion and an insertion region formed from the extension region toward one end of the tab portion, and only the extension region is coated with the fire-resistant material.

8. The battery assembly according to claim 7, wherein a length of the extension region is longer than a length of the insertion region along the direction in which the tab portion protrudes.

9. The battery assembly according to claim 1, wherein the fire-resistant material is foamed at or above a preset temperature.

10. The battery assembly according to claim 9, wherein the fire-resistant material comprises at least one of polyurethane, silica, or ceramic.

11. The battery assembly according to claim 9, wherein the fire-resistant material has insulating properties.

12. The battery assembly according to claim 9, when the fire-resistant material coated on at least one of the battery cells is foamed, the fire-resistant material contacts with a fire-resistant material coated on another battery cell adjacent to the at least one battery cell.

13. A method of manufacturing a battery assembly including an electrode assembly, an outer body for accommodating the electrode assembly, a plurality of battery cells each including a tab portion protruding outwardly from the outer body, and a housing for accommodating the plurality of battery cells, comprising:
a step of coating at least one battery cell among the plurality of battery cells with a fire-resistant material; and
a step of curing the fire-resistant material at or below a preset temperature.

14. The method according to claim 13, wherein the step of coating at least one battery cell among the plurality of battery cells with the fire-resistant material includes a step of covering an accommodating portion forming an accommodating space for accommodating the electrode assembly among the outer body and a step of spraying the fire-resistant material toward the outer body.
